(19) United States
(12) Patent Application Publication
(10) Pub. No.: US 2023/0274583 A1
(43) Pub. Date: Aug. 31, 2023

(54) Methods of exchanging information for the efficient allocation of finite resources

(71) Applicant: Zachary NemniJones, New York, NY (US)

(72) Inventor: Zachary NemniJones, New York, NY (US)

(21) Appl. No.: 17/652,685

(22) Filed: Feb. 26, 2022

(51) Int. Cl. G07B 15/02; G06Q 30/08

(52) U.S. Cl. CPC G07B 15/02; G06Q 30/08

(57) ABSTRACT

The efficient allocation of finite resources is a problem that affects consumers in many aspects of everyday life. Examples of this problem are numerous. For example, in densely populated urban areas, the availability of parking is a problem that frustrates many drivers and even pedestrians. During rush hour, for example, a driver may drive around for significant amounts of time looking for a parking spot. This, in turn, may result in other problems that affect traffic. Some drivers will double-park hoping that a spot may eventually open up. Multiple drivers may vie for the same spot, resulting in additional congestion and, worse off, personal conflict.

### DETAILED DESCRIPTION OF THE INVENTION

Solutions to how to allocate finite resources, like parking spots, are very few and they do not work predictably and efficiently. On streets that include metered parking, a driver may look at the meter to try to estimate when a parking spot may open up. This is a manual and time-consuming effort that requires assumptions that may turn out to be inaccurate. For example, the parking spot may open up before the meter expires because most meters work in hourly increments, but the occupying car may leave sooner than projected or stay longer than the meter projects. The driver of the parked car may also return and add additional time on the meter, making the prediction of a driver wishing to claim the occupied spot inaccurate.

On streets that do not include metered parking, predicting when a spot opens up is even more difficult and at times likely impossible. In traffic-congested cities, drivers may drive around for significant amounts of time looking for a free parking spot, costing them time.

While many urban areas have garages that will usually have available parking, parking in a garage is very expensive. Furthermore, the availability of garages may be scarce, such that the drivers may have to walk or take public transportation to reach their ultimate destination. For example, a driver may use a garage that is 10 blocks away from their home or work, a distance that they will have to either walk or cover using public transportation.

A review of the prior art discloses very rudimentary and/or expensive attempted solutions to address the foregoing problems. For example, an application called ParkWhiz uses maps of an urban area that attempt to identify parking locations within a garage that may be vacant as of a particular point in time. The problem with the ParkWhiz approach is that it is limited to parking within garages. Further, the ParkWhiz approach does not work for street parking, where there is no way to reserve spots in advance, let alone know when free parking spots may open up.

A review of prior art also indicates that drivers looking for free parking occasionally resort to chat rooms/blogs in an attempt to identify parking spots that may open up at a particular time. The problem with this approach is that it does not really work or, if it does, it works inefficiently. The particular location and time when a parking spot may become available is hard to predict. And individuals who are looking for parking or vacating parking spots are highly unlikely to be logging into chat rooms/blogs while driving around.

Another prior art solution described in U.S. Pat. 10,006,2132B2 relies on building expensive infrastructure that detects, via cameras, when particular parking spots become available. This solution presents several problems. First, it is expensive because it would require the installation of a network of cameras to monitor the availability of street parking. Furthermore, this solution does not in fact guarantee that a parking spot identified through the camera would not be taken before the driver looking for parking arrives at the identified location. For example, two drivers may see the same available spot, and the driver that is closer to the spot is likely to occupy it before the driver that is farther located arrives.

The inventions disclosed herein offer novel solutions to these problems. The inventions disclosed herein are premised on the exchange of personal and geolocation information between drivers with the goal of making parking-or any sharing of finite resources-quick, efficient, and inexpensive. The inventions disclosed herein will save drivers time and money, with the added benefit of reducing congestion, traffic, pollution, and frustration. It is understood that the embodiments described herein are exemplary only and non-limiting. The inventions described herein can be applied to a variety of settings that require the allocation of finite resources, and that parking is not the only finite resource persons practicing these inventions may be able to efficiently allocate.

### DESCRIPTION OF THE DRAWINGS

FIG. 1: Once the program / app is launched this is the first screen to show up. On the screen there are two interactive interfaces, both lead the user to a different menu for their intended use of the app / program. To either look for parking nearby or to list their spot.

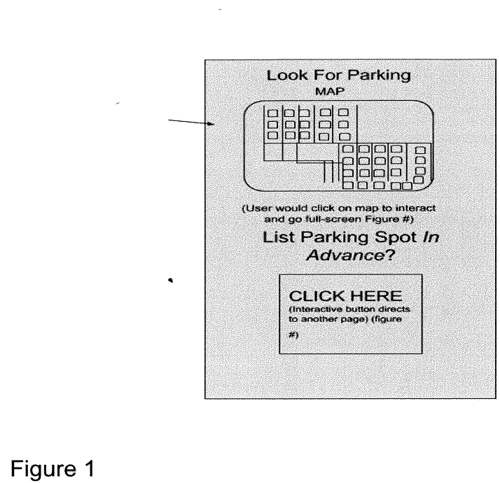

FIG. 2: Is the Interface the user of the application is directed to after clicking on “looking for parking” on FIG. 1. The circles around parts of the map represent the radius or vicinity of where the parking spot for the user is. The number of minutes displayed inside the circle is the estimated amount of time until the spot would be available.

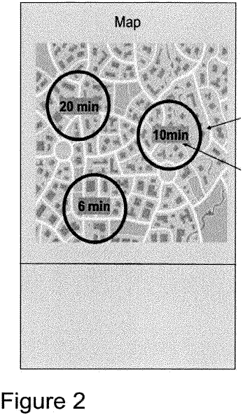

FIG. 3: Once a circle has been clicked on from FIG. 2 then it would direct the user to this verification screen / Interface. This confirmation screen offers more information on the parking spot. For example the street cleaning days and time, the size make and model of the car moving out of the spot, and a YES or NO question to indicate if the user wishes to proceed to claim the spot.

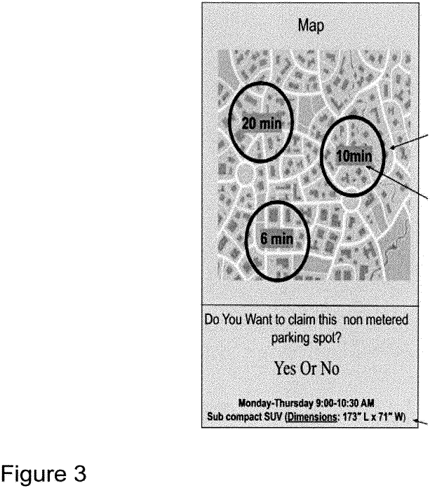

FIG. 4: On FIG. 1 if the “list parking spot in advance” option is pressed then the user would be directed to this screen FIG. 4. This screen asks the user for general information pertaining to their car such as color, make, model and size. The next screen after all this information is filled out asks for the car’s address and alternate parking rules such as days and time. Once all this has been filled out the user would be directed to the final screen confirming the car’s information and parking rules. The application calculates the user’s distance from their car and initiates the countdown once they have moved significantly in the car’s direction.

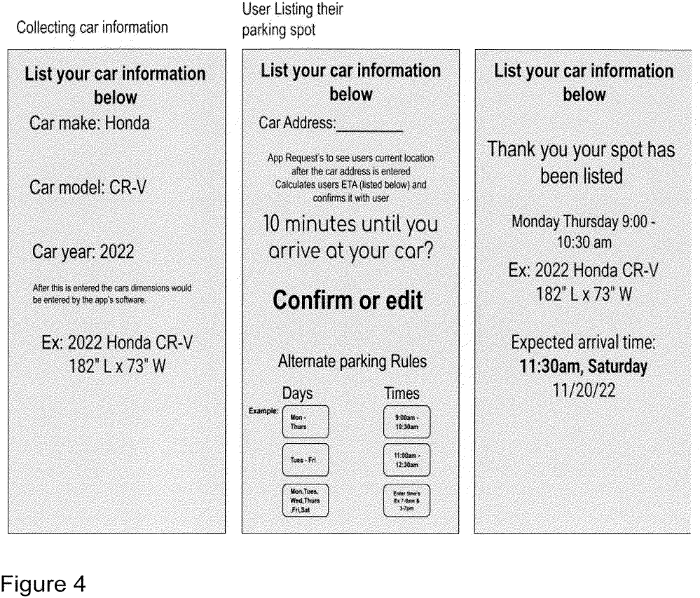

FIG. 5: Illustrates FIG. 4 Listing page.

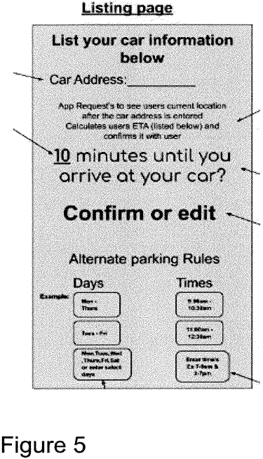

FIG. 6: Offers a better explanation of all the interactive features and requests from the user such as active location.

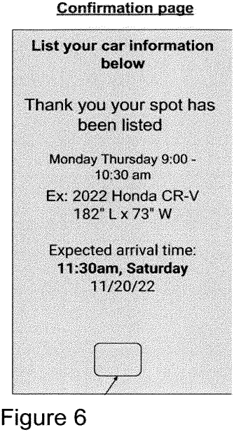

FIG. 7: This figure is another use of the application based on user data. It gets entered into a larger algorithm which calculates the probability of parking spots opening up in certain areas at certain times of the day based on past user patterns.

In one embodiment of the inventions described herein, drivers use a software application program that in the initial instance collects and stores several types of information associated with the driver. For example, the application will ask the driver to identify the type of vehicle they are driving and its approximate size. Where the driver cannot estimate the size of the vehicle, the application will do that for the driver by using a lookup table that contains information about the size of the vehicle. Another type of information the application will solicit the driver to enter concerns the driver’s anticipated parking schedule. A driver may indicate that they will occupy a parking spot for a set duration of time, such as the driver’s workday. A driver may also indicate that they will occupy a parking space for an undetermined period of time, such as during a medical appointment. The application then holds on to this data and, using geolocation information, it records the location of the parking spot occupied by the driver. Next, a set period of time before the driver is expected to vacate their parking spot, the application will publicize to other users of the application who are looking to find parking the location of the parked vehicle and information about the size of the vehicle. In this way, other drivers looking to find parking will know where parking spots may generally open up and whether their vehicles would fit in spots that may become available.

In another embodiment of the inventions described herein, users of the software application program described above may share more particular details about the specific location where a parking spot will become available and the specific time when this will occur. For example, upon the completion of an appointment they are attending, the driver will log back into the application and indicate that they are heading over to their parked vehicle with the intention of leaving the parking spot it occupies. Using the geolocation of the driver, the application will estimate the amount of time the driver will need to reach the parked vehicle. The application will then publicize to other users of the application who are looking to find parking the specific location of the parked vehicle, information about the size of the vehicle, and the time the application calculates it will take for the parking spot to free up. In this way, other drivers looking to find parking will know where particular parking spots will open up and whether their vehicles would fit in the spot that is known to become available.

In another embodiment of the inventions described herein, the software application program will itself, without a prompt from the user, identify the location where the driver has parked their car. The software application program will then monitor the driver’s whereabouts and, when the application detects that the driver is heading back to the parked car, it will publicize to other users of the application who are looking to find parking the specific location of the parked vehicle, information about the size of the vehicle, and the time the application calculates it will take for the parking spot to free up. In this way, other drivers looking to find parking will know where particular parking spots will open up and whether their vehicles would fit in the spot that is known to become available.

In another embodiment of the inventions described herein, users of the software application program described may disclose the information regarding the specific parking location and details of where and when the location will be vacated. This listing can be made in advance, for example a few hours prior, or even a longer time period. If a user wants to reserve the soon-to-be-vacated parking spot in advance they must place an offer to be accepted by the other user. For example, if a user knows they are going to move their car at 8 AM the next day they list it on the application. Then another user who needs to find parking at 8 AM can place an offer on that and have the information regarding the parking for themselves.

In another embodiment of the inventions described herein, users of the software application program described may disclose the information regarding the specific parking location and details of where and when the location will be vacated. This listing can be made in advance or even while the driver of the parked car is sitting in his car ready to vacate the spot. The software application program can then offer the parking spot to other users of the program and conduct a bid among multiple drivers interested in the soon to be available spot. The application will then publicize all of the available bids to the driver of the parked car and allow them to accept the most appealing bid - based on price, proximity of the driver looking for parking, etc.

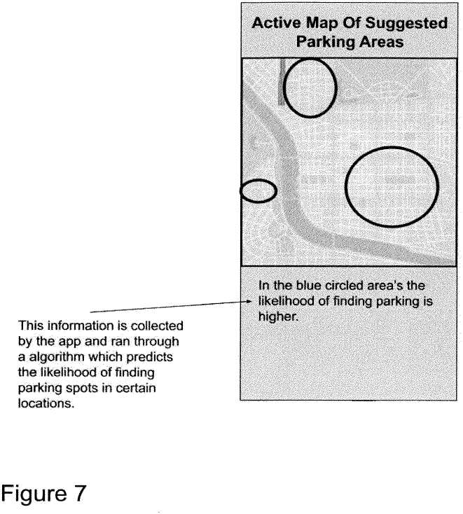

In another embodiment of the inventions described herein, the software will collect user-authorized data to analyze parking movements at certain times. From this data, the software’s algorithm would be able to determine patterns and trends among users moving their cars in densely populated areas. This data would be available to users in the form of suggesting areas that would increase the likeliness of finding parking. (FIG. 7)

What is claimed is:

1. A method of locating limited resources, the method comprising:
using a software program to collect information from one or more users concerning their use of limited resources;
storing the collected information in a server;
analyzing the information collected;
predicting, based on the information collected, when limited resources may be available for reuse; and
publishing the predictions to users of the software program.

2. The method of claim 1 where the limited resources are parking spots.

3. The method of claim 1 where the information collected includes the approximate time when the user expects to free up a limited resource for reuse.

4. The method of claim 1 where the information collected includes the dimensions of the vehicle of the user.

5. The method of claim 1 where the predictions published to the users of the software program include geolocation information.

6. The method of claim 1 where the predictions published to the users of the software program include the approximate time when the limited resource may be available for reuse.

7. The method of claim 1 where the predictions published to the users of the software program include information concerning the type of vehicle that may fit within the limited resource that may be available for reuse.

8. A method of locating limited resources, the method comprising:
using a software program to collect information from one or more users concerning their use of limited resources;
storing the collected information in a server; and
relaying information concerning the availability of the limited resources to other users of the software program.

9. The method of claim 8 where the limited resources are parking spots.

10. The method of claim 8 where the information collected includes the approximate time when the user expects to free up a limited resource for reuse.

11. The method of claim 8 where the information collected includes the dimensions of the vehicle of the user.

12. The method of claim 8 where the information relayed includes the approximate time when the limited resource may be available for reuse.

13. The method of claim 8 where the information relayed includes information concerning the type of vehicle that may fit within the limited resource that may be available for reuse.

14. A method of bidding on limited resources, the method comprising:
using a software program to collect information from one or more users concerning their use of limited resources;
storing the collected information in a server;
relaying information concerning the availability of the limited resources to other users of the software program; and
conducting an auction among users of the software program to select a user who may claim the limited resource for reuse.

15. The method of claim 14 where the limited resources are parking spots.

16. The method of claim 14 where the information collected includes the approximate time when the user expects to free up a limited resource for reuse.

17. The method of claim 14 where the information collected includes the user’s geolocation information.

18. The method of claim 14 where the information collected includes the dimensions of the vehicle of the user.

19. The method of claim 14 where the information relayed includes the approximate time when the limited resource may be available for reuse.

20. The method of claim 14 where the information relayed includes information concerning the type of vehicle that may fit within the limited resource that may be available for reuse.
